(19) United States
(12) Patent Application Publication
(10) Pub. No.: US 2006/0141180 A1
(43) Pub. Date: Jun. 29, 2006

(54) Shoes included natural germanium

(76) Inventor: Ju Sik Park, Busan (KR)

Correspondence Address: LADAS & PARRY LLP, 224 SOUTH MICHIGAN AVENUE, SUITE 1600, CHICAGO, IL, 60604, US

(21) Appl. No.: 10/559,416

(22) PCT Filed: Jun. 4, 2004
(86) PCT No.: PCT/KR04/01349

§ 371 Date: Jan. 26, 2006

(30) Foreign Application Priority Data
Jun. 7, 2003 (KR) 10-2003-0036579

(51) Int. Cl. B31B 45/00

(52) U.S. Cl. 428/34.4; 428/34.1

(57) ABSTRACT

The present invention relates to footwear in which natural germanium ore powder is added to the uppers of leather portion (an outer cover, an inner cover and a middle cover) and sole portions (an inner sole, a Taxon portion, a middle sole and a bottom sole) in all kinds of footwear such as shoes, running shoes, golf shoes, indoor shoes, sandals and work shoes. Germanium (Ge) is a material that emits a large amount of far-infrared rays. Germanium has a thermo effect of the human body and efficacy of promoting equilibrium of the autonomic nervous system and the amount of skin blood flow. Further, germanium has effects that it promotes circulation of blood and metabolism, shuts electromagnetic waves and prevents static electricity.

### TECHNICAL FIELD

The present invention relates to footwear having natural germanium (Ge) added thereto. More particularly, the present invention relates to footwear having natural germanium added thereto in which natural germanium ore powder is added to the uppers of a leather portion made of natural leather or synthetic leather and urethane form and sole portions having an inner sole, a middle sole and a bottom sole in all kinds of footwear such as shoes, running shoes, golf shoes, indoor shoes, sandals and work shoes.

### BACKGROUND ART

Conventionally, functional footwear fabricated using components such as natural jade, elvan, permanent magnet and germanium have been known. In this footwear, however, those components are adhered using an adhesive or embedded in an additional device. Thus, these functional materials easily fall off. It is attended by many evils that its functionality is lost.

### DISCLOSURE OF INVENTION

Accordingly, the present invention has been made in view of the above problems. According to the present invention, the uppers of leather portion 2 (natural leather, synthetic leather and urethane form) and sole portions 3 (an inner sole, a middle sole and a bottom sole) of a footwear body 1 are fabricated using germanium ore powder 1a in which a natural ore containing a germanium (Ge) component of 0.36 to 1.05% is crushed to 350 to 500 mesh and is then sintered at a temperature of 400° C.

First, in forming the uppers of leather portion 2, a cellulose acetate/acetone solution of 1 to 2% and germanium ore powder 1a of 3 to 20% are impregnated into the uppers of leather material of 78 to 96 weight %. Next, in forming the sole portions 3, the germanium ore powder 1a of 3 to 20 weight % is added to a chemical material of 80 to 97 weight % such as common rubber, Pu and EVA.

Functional footwear in which the uppers of leather portion 2 and the sole portion 3 are combined has effects of an antibiotic action, smell removal, shielding of electromagnetic waves and prevention of static electricity, and can be used longer than conventional various functional footwear.

### BRIEF DESCRIPTION OF DRAWINGS

Further objects and advantages of the invention can be more fully understood from the following detailed description taken in conjunction with the accompanying drawings in which:

FIG. 1 is a perspective view illustrating footwear according to the present invention;

FIG. 2 is a cross-sectional view of the footwear taken along lines A-A in FIG. 1;

FIG. 3 is a partially expanded view showing a portion B in FIG. 2;

FIG. 4 is a partially expanded view showing a portion C in FIG. 2;

FIG. 5 is a partially expanded view showing a portion D in FIG. 2; and

FIG. 6 is a partially expanded view showing a portion E in FIG. 2.

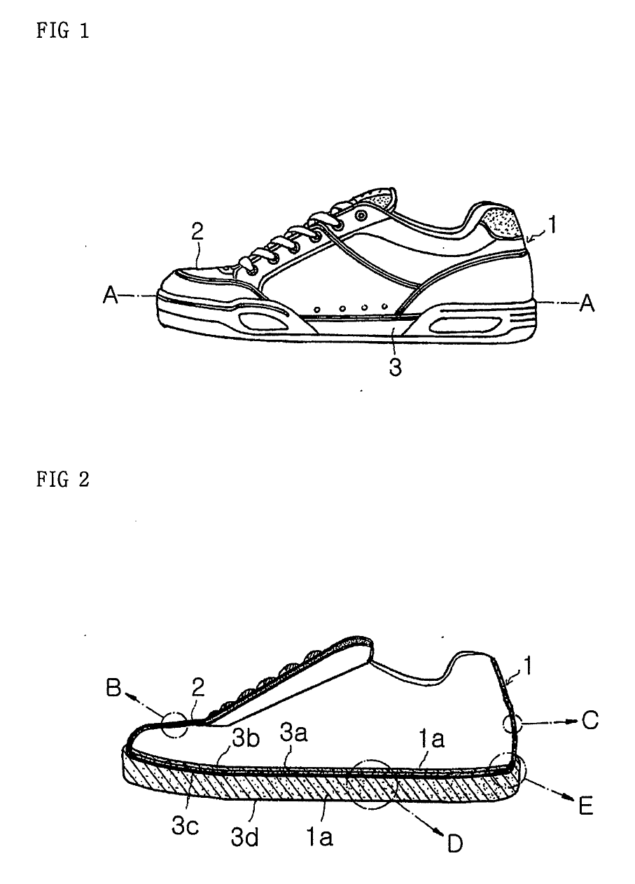

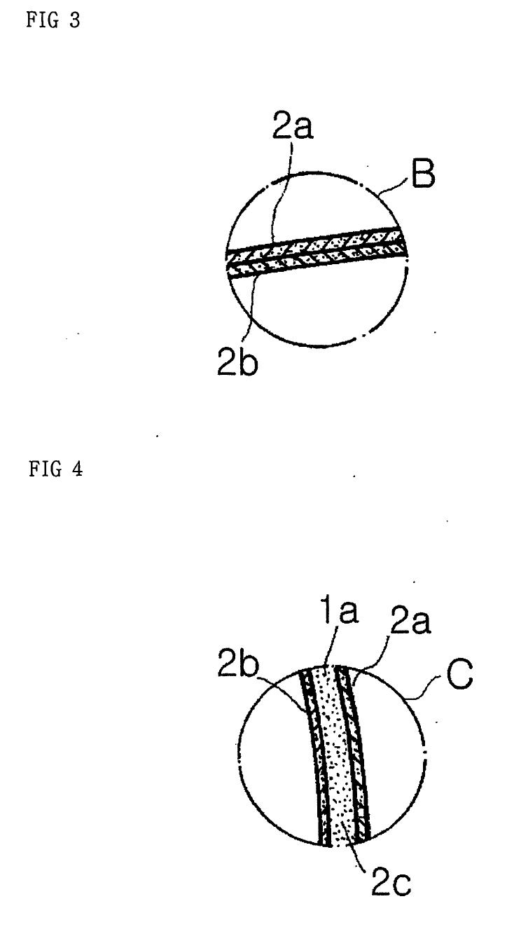

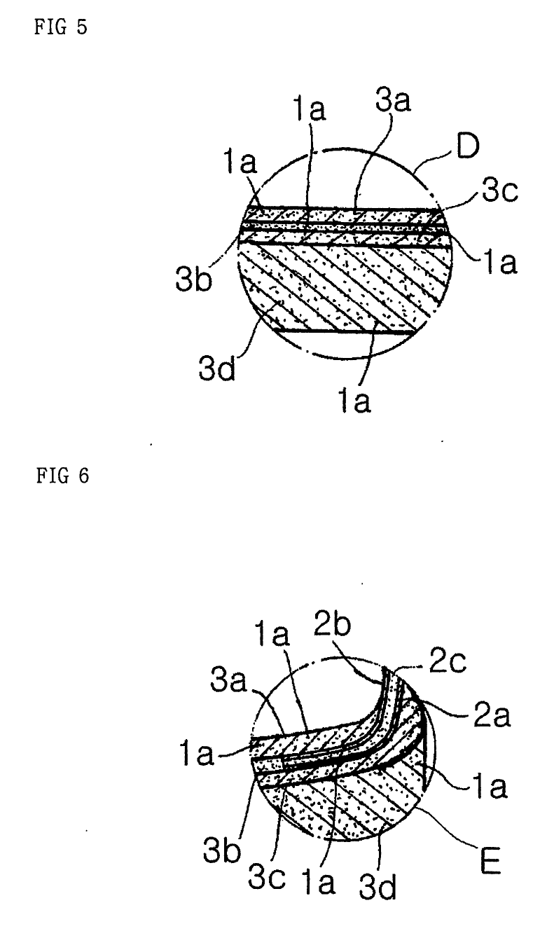

### BEST MODE FOR CARRYING OUT THE INVENTION

The present invention will now be described in detail in connection with preferred embodiments with reference to the accompanying drawings.

A germanium (Ge) ore used in the present invention is a Cu3 (Gefe)S4 type (germanite type) ore that was mined at a germanium mine located in Sannae-myeon, Gyeongju-si, Gyeongbuk, Korea. The ore contains a germanium component of 0.36 to 1.05%. A detailed component of the ore is as follows.

| Component | Content |
|---|---|
| Cu | 0.044 |
| Pb | 4.72 |
| Zn | 0.42 |
| Fe | 25.8 |
| Mn | 0.36 |
| Ni | 0.56 |
| Cd | 0.018 |
| Ge | 0.36 to 1.05 |
| Mg | 6.60 |
| C | 0.6 |
| As | 15.4 |
| S | 17.6 |
| SiO₂ | 17.2 |
| CaO | 0.61 |
| Moisture | 9.018 to 9.708 |

Cu3 (Gefe)S4 type germanium (Ge) has a property that it radiates far-infrared rays of 94%.

The far-infrared rays are a kind of light having the range of about 5.6 micron to 1000 micron in wavelength. When the rays are radiated toward all living things, it promotes physiological activities of the human body. Thus, the far-infrared rays are applied to various medical and life products. These far-infrared rays have many uses such as freshness maintenance, a maturing function, a smell removal function, a purification function and water activation depending on a product.

A method for manufacturing a germanium ore powder 1a includes sintering a natural ore containing germanium at a temperature of 400° C. to make the ore crushed to 350 to 500 mesh.

More particularly, a component of the germanium ore contains a very small amount of essential minerals, pottasium, calcium, silica, alumina, iron, manganese, etc. A crush method of this ore employs a crusher or a ball mill. In particular, germanium is a material that emits far-infrared rays suitable for the human body. The radiation effect of the far-infrared rays has complex efficacy such as growth acceleration of the human body, a thermo effect, shielding of electromagnetic waves, prevention of static electricity and acceleration of equilibrium of the autonomic nervous system, and serves to accelerate circulation of blood and metabolism.

According to the present invention, the germanium ore powder 1a of 350 to 500 mesh is added to the uppers of leather portion 2 and a sole portion 3 of a footwear body 1.

In the footwear body 1, a process of fabricating natural leather 2a such as sheepskin, cows kin or pigskin in the uppers of leather 2 will be now described.

The natural leather 2a is first experienced by a soaking process and a liming process. Animal fat is removed from the natural leather 2a by means of a tanning process. The natural leather 2a is then experienced by a combination tanning process and then a finishing process. Thereby, vegetability leather is produced. In the above, upon the composition tanning process following the tanning process, cellulose acetate/acetone solution of 1 to 2% and germanium (Ge) ore powder 1a or 3 to 20% are impregnated into the uppers of leather material of 78 to 96 weight %.

Furthermore, in case of synthetic leather such as Pu or PVC, woven fabric is first put into a liquefied tank containing DMF. The woven fabric is solidified through a solidification bath and is then cleaned in a washing bath. The woven fabric is then dried in a drying oven. In the above, germanium (Ge) ore powder of 3 to 20 weight % is impregnated into the liquefied tank.

An aqueous solution of the germanium (Ge) ore powder of 3 to 20 weight % is impregnated into a synthetic leather material of 80 to 97 weight % of the inner cover 2b made of fabric attached to the outer cover 2a made of leather. In case of the middle cover inserted into the heel and the fore uppers of leather portion, a resilient middle cover 2c made of urethane form is used. Even in the middle cover, germanium ore powder 1a is added in the same manner as the above.

Furthermore, a sole portion 3 includes an inner sole 3a, a Taxon portion 3b, a middle sole 3c and a bottom sole 3d. In order to fabricate the inner sole 3a, the Taxon portion 3b, the middle sole 3c and the bottom sole 3d, a rubber material, a synthetic resin material, etc. that are suitable for respective uses are mixed. The germanium ore powder 1a of 3 to 20 weight % is then added to the mixed chemical material of 80 to 97 weight %. Next, the results are agitated in an agitator and are then compressed by a press machine.

As described above, in fabricating the footwear body 1, the uppers of leather portion 2 at the top that includes the germanium ore powder 1a and the sole portion 3 at the bottom are combined by means of a common method. It is to be noted that the present invention is not limited to the above but can be applied to all kinds of footwear such as shoes, running shoes, golf shoes, indoor shoes, sandals and mountain-climbing boots.

In particular, the spots on the body suitable for acupuncture connected to the five viscera and the six entrails are gather at the sole of the foot. Thus, in case where a user wears the footwear according to the present invention, a large amount of far-infrared rays are generated from the germanium ore powder 1a by means of radiant heat that is generated from the wearer's foot. Therefore, it improves circulation of blood of the wearer and cuts off electromagnetic waves. Furthermore, fatigue at the foot, leg and whole human body is reduced.

INDUSTRIAL APPLICABILITY

According to the present invention, in fabricating footwear to which germanium (Ge) is added, germanium ore powder 1a in which a natural ore containing a germanium component of 0.36 to 1.05% is crushed to 350 to 500 mesh is digested in an aqueous solution of 3 to 20% in concentration in the uppers of leather portion (natural leather, synthetic leather and urethane form) of footwear. In forming a sole portion (an inner sole, a middle sole and the bottom sole), germanium ore powder 1a of 3 to 20 weight % is added to a chemical material of 80 to 97 weight % such as common rubber, Pu and EVA and is then compressed.

Therefore, footwear according to the present invention has effects that it has the life span longer than conventional functional footwear, accelerates circulation of blood of the human body and has a good antibiotic action since smell occurring footwear is removed. Furthermore, when a user wears footwear according to the present invention, radiation of far-infrared rays is amplified by radiant heat generated from the foot. Therefore, fatigue in the foot and leg is reduced and footwear culture is significantly improved.

What is claimed is:

1. Footwear having the uppers of leather portion 2 made of synthetic leather or natural leather 2a and a sole portion 3 made of a rubber material and synthetic resin,
wherein a natural germanium ore containing a germanium (Ge) component of 0.36 to 1.05% is crushed to 350 to 500 mesh, and germanium ore powder 1a that is sintered at a temperature of 400° C. is then added to the uppers of leather portion 2 and the sole portion 3.

2. The footwear as claimed in claim 1, wherein the uppers of leather portion 2 includes an outer cover 2a made of natural leather and an inner cover 2b made of synthetic leather such as Pu and PVC, or the middle cover 2c made of urethane form, and
a cellulose acetate/acetone solution of 1 to 2% and germanium ore powder 1a of 3 to 20% are impregnated into the uppers of leather material of 78 to 96 weight %.

3. The footwear as claimed in claim 1, wherein the sole portion 3 includes an inner sole 3a, a Taxon portion 3b, a middle sole 3c and a bottom sole 3d, all of which are formed using a mixture of a rubber material and synthetic resin, and
when these soles are shaped, germanium ore powder 1a of 3 to 20% is mixed with a material of 80 to 97 weight % such as rubber, Pu and EVA.
